(19) United States
(12) Patent Application Publication
(10) Pub. No.: US 2004/0201774 A1
(43) Pub. Date: Oct. 14, 2004

(54) Docked camera becomes electronic picture frame

(76) Inventor: K. Douglas Gennetten, Ft Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/855,457

(22) Filed: May 15, 2001

(51) Int. Cl. H04N 5/225; H04N 9/04

(52) U.S. Cl. 348/375; 348/207.99

(57) ABSTRACT

A digital camera mounted to a camera dock so as to function as an electronic picture frame that includes a mounting portion for receiving a digital camera; and a support portion pivotally coupled to the docking portion where the support portion is in contact with a surface.

### BACKGROUND OF THE INVENTION

1. Field of the Invention

This invention relates generally to digital cameras and more particularly to a docked digital camera that becomes an electronic picture frame.

2. Description of Related Art

A digital camera records and stores photographic images in digital form that can be fed to a personal computer (PC) as the impressions are recorded or stored in the camera for later loading into the PC. Special software for the particular digital camera is loaded onto the PC for downloading the images from the camera memory and/or processing of the downloaded images. It is well-known to mount both conventional and digital cameras on a camera tripod and/or other similar well-known camera mount. Conventional camera mounts include a threaded screw on a mounting surface. Conventional and digital cameras include an industry standard threaded mounting hole located on a bottom surface of the camera. The threads of the mounting hole match the threads of the screw on the mounting surface of the camera mount. Most digital cameras come with at least an optical viewfinder, the same kind as found on traditional film cameras. Digital cameras may also include a liquid crystal display (LCD) built into the camera that conveys information to a user with respect to the operation of the camera, such as how many more images are capable of being taken and stored by the camera. Other digital cameras include an LCD built into the back of the camera capable of displaying, in color, the images recorded and stored in the camera. The LCD screen may be used as a viewfinder to allow a user to preview an image before taking the digital image. The LCD also allows a user to view those digital images already taken and stored within the camera's memory.

Digital cameras use solid-state memory flash cards to store images. These flash cards are typically nonremovable memory chips embedded within the camera. More commonly, digital cameras store photos on a removable card that must then transfer files to the computer. These cards, which can range in size from 4 to 256 MB, come in two primary configurations—CompactFlash and SmartMedia. Additionally, some newer cameras accept the new CompactFlash drives, which provides up to 1 GB of storage space for data. However, a card reader or adapter is required to read files into the PC which must be connected to the PC's small computer systems interface (SCSI) or universal serial bus (USB) port if a card slot is not built into the PC. Smart Media cards store a maximum of 64 megabytes which must be downloaded on a reader that goes into the PC's floppy disk drive. Once the card is placed in the reader, the PC's transfer software is launched to transfer the photos from the camera. The camera must be connected to the PC in order to transfer photos from the camera to the PC. Some digital cameras can output photos directly to a floppy disk or via cable to a PC.

Digital cameras consume a great deal of battery power. Many digital cameras are plugged in to a wall socket for stationary use while other cameras use external battery packs as a power source. When a digital camera is connected, or docked, to a PC, its color display is generally turned off and unusable. When a camera is un-docked, its LCD consumes too much power to be left on for any length of time. When the digital camera is in use, it is suggested by manufacturers that the camera's LCD be turned off to conserve battery power for taking digital images and storing those images within the camera's memory.

Once images are transferred from a digital camera to a PC, each image may be printed into hard copy form using a color printer. Software used in conjunction with the camera and PC allows the images taken by the camera to be viewed on the PC. Images may then be saved to a floppy disk or hard drive. Images can be saved in a specific graphic file format, e.g., gif or jpg for Web publishing, pcx or bmp for paper publishing. A graphics program, such as Paint Shop Pro, may be used to edit the images.

As outlined above, a large number of operations are required just to simply view the images taken by a digital camera on anything other than the camera's LCD. Displaying digital photos for any extended period of time is complicated by the limited number of viewing options. As stated above, digital images may be displayed on a PC or in hard copy form. Methods have been developed by which digital images may be shared and/or displayed in electronic form. After film from a conventional camera is developed, the resulting photographs may only displayed in hardcopy form after photographic papers have been exposed to the photographic negative and developed. Digital cameras avoid the need to develop images taken by the camera at a photo lab and/or convert images taken by the camera from analog to digital form. After digital photos have been downloaded from a digital camera, the photos may be loaded onto a Web site, sent to a friend on a floppy disk or sent via email. As stated above, traditional prints may also be created from digital images.

Provided a user has an appropriate computer program, the user may display their digital photographs on their computer. A user may also display their photographs on their own Web site or a public Web site dedicated to sharing photographs. However, due to the viewing size limitations imposed by the user's computer monitor, it may not be possible for the user to utilize a computer program, such as a word processing program, and display photos, stored within the computer or downloaded from a photo sharing Web site, on the monitor screen simultaneously.

One solution to the problem of displaying digital photographs while utilizing a computer program which has a display that occupies at least a majority of the monitor's screen size is to display the photos in an electronic picture frame (EPF). However, electronic picture frames are expensive, single-purpose devices that take up extra space beyond that required by the PC and digital camera.

The Cieva Picturebox is an Internet Connected Digital Picture Frame. The Ceiva allows users to transmit digital images directly from the Internet into an electronic picture frame. The Ceiva Picturebox is essentially an LCD mounted in a frame with electronics, including a built in modem, which operates by plugging an electrical cord running from the Cieva Picturebox into a standard electrical outlet and a phone wire running from the Cieva Picturebox into a telephone jack in the wall. Authorized users must upload their photos to Ceiva's Web site and each night the frame automatically checks for new images and downloads any that were received. The Cieva picture frame can switch between either displaying a single image or cycling through a collection of multiple images, and control manual photo downloads. Located within the Ceiva picture frame is a microprocessor which directs the collection and display of the images, along with a one MB flash memory card which holds approximately ten photo images. When the Ceiva frame dials up a local access number in order to check for new images to download, the Ceiva Picturebox removes existing images on a one-for-one first-in/first-out basis to download any new photos which have been posted to the user's account. Purged photos are then stored back on the user's account at the Ceiva website. There is also a feature which allows the user to lock images onto the user's picture frame and not have them replaced by newer images. The download process takes approximately 4-5 minutes to complete a full ten photo download and the user's connected telephone line is obviously unavailable during this period of time. Because the frame incorporates flash memory, it can be disconnected from an AC electrical outlet and moved to a new location without losing the last set of images displayed on the unit. The user can vary the slideshow interval (through the user's account at the Ceiva website) and customize images by adding captions to the images. The Ceiva picture frame screen is a passive-matrix LCD which measures approximately 5″×7″. The Ceiva includes an AC power supply so it can be active at all times. A frame displays up to 10 images in a rolling queue. Ceiva's system accepts 15 different file formats (JPG, TIF, BMP and etc.) and converts the file formats to 64 KB JPEG files for transmission and display on the frame. Users have the option of sending photos to another Ceiva, sending photos to an online photo album or securing the photo so that when a download occurs, the photo is not deleted from the user's frame.

However, in order to activate the Ceiva Picturebox, the user must be connected to the Internet; an online account must also be set up with a user name, password and buddy list, that tells the Ceiva Picturebox from whom it can receive digital images. The person setting up the online account must also pay a monthly fee. A user who merely receives digital photos on their Picturebox from another party need not set up their own online account but a user wishing to display their own digital photos must set up their own account. It is also necessary to place the frame close to a phone and power outlet. The Picturebox is a single purpose device with an expensive LCD. The Picturebox is useless without the monthly proprietary service.

Another EPF is the SONY Cyberframe Video Photo Frame which uses memory sticks to display a series of digital photos. The CyberFrame Video Photo Frame includes an LCD disguised as picture frame where the LCD is a 5.5″ Active Matrix Color LCD Screen (224K Pixels). The CyberFrame is a video picture frame that displays still images or MPEG movies stored on Memory Stick media. Several images may be displayed in one fill color, large 5.5″ LCD constantly running in a slide show mode. Memory Stick storage media capacity ranges from 4 MB to 16 MB. CyberFrame will playback file formats such as JPEG or MPEG in a variety of different resolutions. For example, a user can display JPEG in UXGA (1600×1200), SXGA (1280×960), XGA (1024×768), or VGA (640×480). For MPEG playback a user can play the movies in a Presentation Mode (320×240), or Video Mail mode (160×112). CyberFrame further includes a built-in speaker with volume control. Cyberframe includes a slide show mode that allows a user to create a slide show of several favorite images. A user can change the interval between images. Cyberframe also includes a repeat mode which allows a set of images to run constantly. A user can also decide which images are to be deleted or protected by selecting a particular image using either the “delete” or “protect” function buttons. Cyberframe further includes an index mode which allows the user to view six (6) thumbnail images at a time. This provides the user with a visual display of what order the images are in. CyberFrame automatically detects the difference between Portrait images and Landscape images and adjusts the displayed image accordingly. A touchless sensor activates/deactivates the CyberFrame with a wave of the user's hand. The Cyberframe is a single purpose device with an expensive LCD.

In information technology, a user interface (UI) is everything designed into a device with which a human being may interact—including display screen, keyboard, mouse, light pen, the appearance of a desktop, illuminated characters, help messages, and how a device, application program or Web site invites interaction and responds to the interaction. Devices attached to a PC or notebook (for example, printers, CD Writers or EPFs) tend to have very limited UIs which may include an online/offline button or a graphical message on an LCD (for example, a “paper jam” or “out of paper” message). These attached devices primarily depend on the UI of a PC or notebook computer for instructions with respect to which operation to execute (for example, print an image or copy a particular image to a CD). As outlined above, conventional EPFs are not capable of creating digital images, only displaying digital images. Even then, conventional EPF require a number of devices to support the EPF, including phone and internet connections, simply in order to display digital images.

### SUMMARY OF THE INVENTION

In accordance with an embodiment of this invention, a camera dock includes a mounting portion for receiving a digital camera and a support portion pivotally coupled to the docking portion. The support portion is in contact with a surface. The mounting portion further includes a port for receiving a cable for power and data connections. The cable is connected to a processor of an outside device.

In accordance with an embodiment of this invention, a method of displaying digital images includes coupling a digital camera to a camera mount such that the camera mount is electrically connected to the digital camera. Digital images are displayed on an LCD of the digital camera.

This invention will be more fully understood in light of the following detailed description taken together with the accompanying drawings.

### BRIEF DESCRIPTION OF THE DRAWINGS

FIG. 1A illustrates an orthogonal view of a side of digital camera mounted to a camera dock 3 where this side faces a user.

FIG. 1B illustrates an orthogonal view of the side of the digital camera/camera mount combination of FIG. 1A that faces away from a user.

FIG. 1C illustrates an orthogonal view of the camera and dock where a portion of the camera mount is cut-away to reveal the mounting surface of the camera mount.

FIGS. 2A-H illustrate various modes of a docked camera.

FIG. 3A illustrates a cross-sectional view of a digital camera positioned above a camera mounting surface.

FIG. 3B illustrates a cross-sectional view of a digital camera mounted to the camera mounting surface of FIG. 3A.

FIG. 4A illustrates a side view of a camera mounting surface.

FIG. 4B illustrates a side view of a digital camera mounted to the surface of FIG. 4B.

FIG. 4C illustrates a bottom view of a digital camera mounting hole.

Use of the same reference symbols in different figures indicates similar or identical items.

### DETAILED DESCRIPTION OF THE PREFERRED EMBODIMENTS

A new docking solution for digital cameras provides power and data connections as well as a new capability: the electronic picture frame experience. In accordance with an embodiment of the invention, the new docking solution includes a digital camera coupled to a camera dock. The digital camera is placed with its LCD facing towards the user. The camera may be tilted and positioned at an angle with respect to a vertical orientation. The digital camera is also provided with power and data connections. The moment the camera is docked, the LCD acts as a user interface (UI) for the camera which is transformed into an electronic picture frame. This picture frame may be configured to present a slide show of recently taken photos or to display older photos semi-permanently stored on the camera. Roughly 250-1000 images may be stored per megabyte of storage space. Digital cameras provide approximately 32-64 megabytes of storage. A camera memory can be expanded up to 250 megabytes. Disk drives (essentially mini-hard drives) may be added to digital cameras to increase memory up to 250 megabytes. In this case the slide show could be programmed to sequence through or randomly select from a very large collection of photos. In the alternative, the electronic slide show can be programmed to sequence through photos contained on a connected PC, notebook computer or photo storage device. However, such a connection is not required. A camera can also be programmed to receive images from a remote device (and/or location) using various means including, without limitation, internet, modem (wireless or otherwise), local area network (LAN), local wireless or wireless internet.

A UI solution for displaying digital images provides the aforementioned devices with greater independence from PC and notebook computers and digital cameras with power and data connections. A camera docking solution includes a camera docking interface that does not interfere with important controls and surfaces of existing or future camera designs of digital cameras. This illustrative docking solution does not require the addition of interfaces to the exterior of a digital camera and may be used in a variety of digital camera docking situations including, without limitation, camera tripods, photo printers, docking stations. In accordance with an embodiment of this invention, this illustrative camera dock provides data and power connections to a digital camera using existing interfaces. In accordance with another embodiment of this invention, this illustrative camera dock provides data and power connections within the confines of the industry screw mount standard. The UIs of digital cameras are increasing in functionality to the point where the cameras are reaching the functionality of present-day personal digital assistants (PDA). Camera LCDs are reaching computer-screen quality and starting to employ touch-screen capabilities. While more limited than the UI of a PC or notebook computer, the UI of a digital camera provides greater functionality than the limited UIs found in conventional EPFs.

A digital camera that doubles as an EPF allows digital images to be displayed with greater independence from PC and notebook computers. Many PC monitors are not large enough to allow a user to display a program the user is working in while simultaneously displaying digital images. Using the LCD of the digital camera to display digital images frees up the full screen of the computer monitor for the user. A camera docking solution transforming the camera into an EPF includes a camera docking interface that does not interfere with important controls and surfaces of existing or future camera designs of digital cameras. This illustrative docking solution does not require the addition of interfaces to the exterior of a digital camera and may be used in a variety of digital camera docking situations including, without limitation, camera tripods, photo printers, docking stations. This illustrative camera dock provides data and power connections within the confines of the industry screw mount standard. As stated above, conventional EPFs require a number of additional accessories and support services simply in order to display digital images and mimic the display abilities of a digital camera.

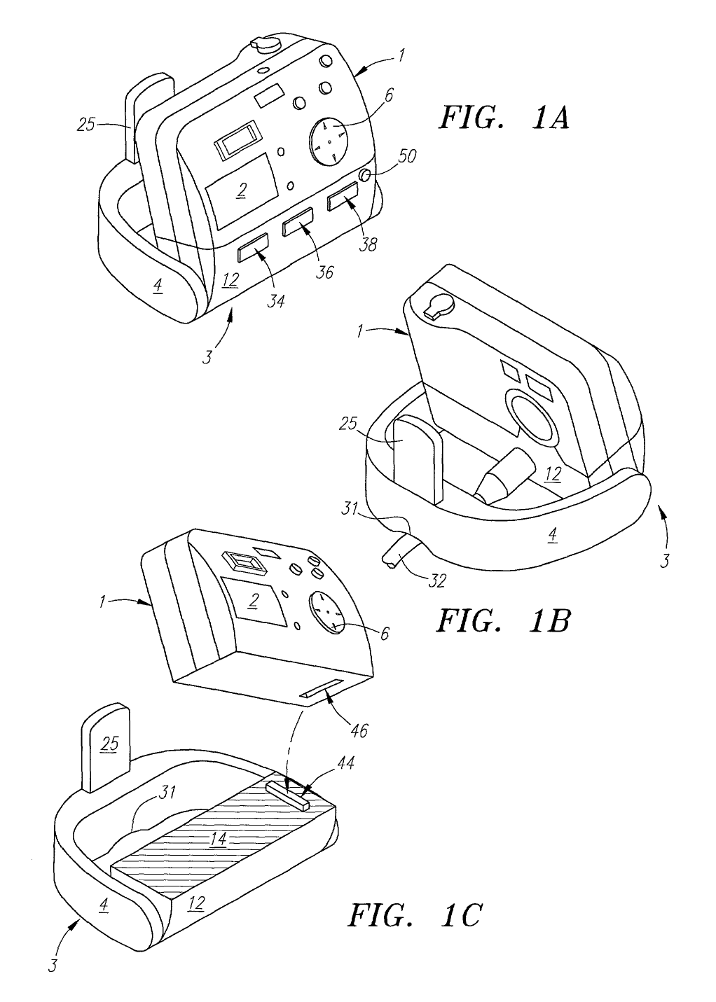

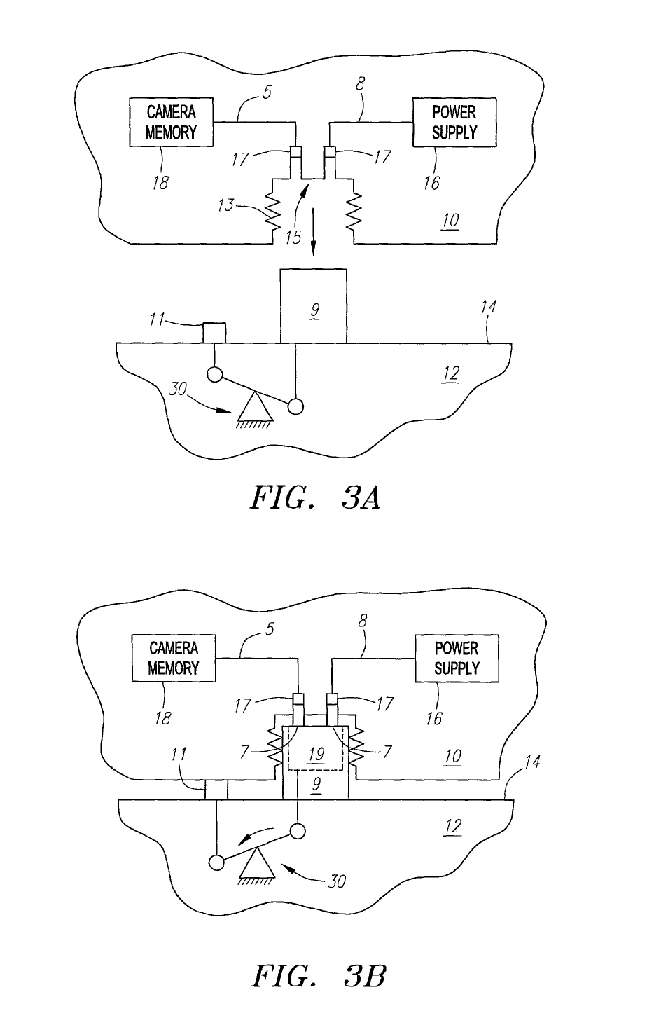

In accordance with an embodiment of the invention, FIG. 1A illustrates an orthogonal view of a side of digital camera 1 mounted to a camera dock 3 where this side faces a user. Digital camera 1 includes an LCD 2 that displays images contained within a camera memory 18 (FIGS. 3A & 3B). LCD 2 functions as a UI. The UI of camera 1 has the capability to start and stop a slide-show of images stored in the memory of the camera. This slide-show can be configured as the default mode of the camera. However, the camera can be programmed to display the images in any sequence. The camera memory includes a date stamp for every image. Therefore, the memory can be programmed to display images in any desired chronological order. Existing buttons on a digital camera can be used to control the endpoints of the data range for photo display. Existing buttons, such as Four-way button 6, also allow a user to fast-forward through the slide-show. Four-way button 6 allows a user to interrupt the default mode so that the user can move through the stored images to a desired image. The trend toward larger displays and touch-screen support further enhances the value of this invention. Digital camera 1 acts as a conventional digital camera prior to docking with camera dock 3. When camera 1 is docked, the connection between camera 1 and dock 3 is engaged, notifying the processor of camera 1 that camera 1 is now docked. The processor executes a program that displays images stored within the processor (e.g., a slide-show program) which allows camera 1 to function as an EPF. When camera 1 is undocked, the processor is alerted that the connection between camera 1 and dock 3 is no longer there and camera 1 reverts to its conventional functions. Camera dock 3 includes a camera mount 12 pivotally connected to a base 4. In the alternative, camera mount 12 may include a release button for disconnecting camera 1 from camera dock 3.

Camera 1 does not ‘snap-fit’ into dock 3 so much as camera 1 connects to dock 3 by gravity alone and is guided mechanically. Camera mount 12 is made of plastic and may be colored so as to mimic the color of the casing of digital camera 1. For example, the outer casing of many digital cameras are a dull silvery-steel color. Camera mount 12 may be colored to match the color of the camera's casing in order to blend the mating of camera 1 and camera mount 12 and further the illusion that camera 1 and camera mount 12 are of single piece construction. Base 4 may be shaped in a variety of configurations including, without limitation, U-shaped. Base 4 may also be colored to match the color of the casing of camera 1. Base 4 made of plastic. Base 4 may also be made of a translucent material, such as plastic, and come in a variety of colors (for example, purple, blue, orange, red, or green).

In accordance with an embodiment of the invention, FIG. 1B illustrates an orthogonal view of the side of the digital camera/camera dock combination of FIG. 1A that faces away from a user. Camera 1 mates with dock 3 in a number of ways, including without limitation snap-fitting and glide-fitting (i.e., mount 12 is molded to the shape of the body of camera 1 so that when camera 1 is snug-fit to mount 12). An infra-red remote sensor 25 is mounted on base 4. Infra-red remote sensor 25 operates in the same manner as video or film camera remotes. Infra-red remote sensor 25 allows camera 1 to be operated remotely using a conventional infra-red remote control device. Cable 32, which runs to camera mount 12 from an outside device, is a USB connection to the PC; providing both data connections (between camera 1 and an outside device) for transferring information and power connections (between camera 1 and an outside device) for powering camera 1.

Base 4 further includes an indentation 31 which provides sufficient clearance to allow power/data cable 32 to pass under base 4 without lifting base 4 off the surface it is resting upon. In the alternative, base 4 may further include a pivot so as to rotate base 4 up to 360 degrees. Camera mount 12 includes a power/data cable port 33 (not shown for clarity) with which cable 32 mates (FIG. 1B).

In accordance with an embodiment of the invention, FIG. 1C illustrates the connectors used to mate camera 1 and dock 3. Power/data cable port 33 is connected by cable or wire to camera mount connector 44. The bottom surface of camera 1 has a connector 46 which mates to camera mount connector 44. The pins of each connector mate so as to provide power and data connections between camera 1 and dock 3. In the alternative, cable 32 may directly mate with connector 46 of camera 1 through an opening in a surface 14 of camera mount 12.

Camera mount 12 is pivotally connected to base 4 such that camera mount 12 may be tilted at an angle with respect to the surface on which dock 3 is resting in the same manner that traditional photo frames are at an angle with respect to the surfaces on which they rest. Friction keeps mount 12 from pivoting from the weight of camera 1. In the alternative, a ratcheting pivot mechanism may be used to hold the camera in a desired position. Dock 3 acts as a charger, a data connection, and a mode change (i.e., camera 1 functions as an EPF rather than a digital camera). Dock 3 allows digital images to be displayed that were downloaded via internet connection from a website where digital images are stored or exchanged peer-to-peer.

Dock 3 is not dependent on being connected by cable to a PC, notebook computer or other device. Dock 3 may be arranged in a “stand alone” configuration; operationally connected by an RF connection to a PC, or by wireless or wired connection to a cell phone. Camera mount 12 may be molded so as to fit a particular camera or constructed as a universal dock. When camera 1 is disconnected from dock 3, dock 3 folds up for easy storage and convenient transport. Dock 3 has no memory (i.e., processor) of its own. Information transferred to and from camera 1 through USB cable 32 (FIG. 1B) which connects into the base of dock, through the dock connector into the camera. USB cable 32 provides both data and power connections. Power from cable 32 to camera 1 may directly power camera 1 rather than recharge the batteries of camera 1. In the alternative, power from cable 32 may be used to recharge the camera's batteries as well as directly power camera 1. Cable 32 connects to a PC, notebook computer or other device through an interface device located within the device. In this manner, the digital camera is connected to a memory (e.g., central processing unit (CPU)) and/or main power supply of the device.

In accordance with an embodiment of the invention, a camera dock provides power for a digital camera and its battery recharge cycle. In an alternative embodiment, dock 3 could be part of a larger device including, without limitation, a photo printer, a CD Writer, or any other small device requiring an image data source. Dock 3 also provides a data connection to transfer images between camera 1 and another device. Dock 3 enables camera 1 to undergo a change in mode from functioning as a digital camera to functioning as an EPF.

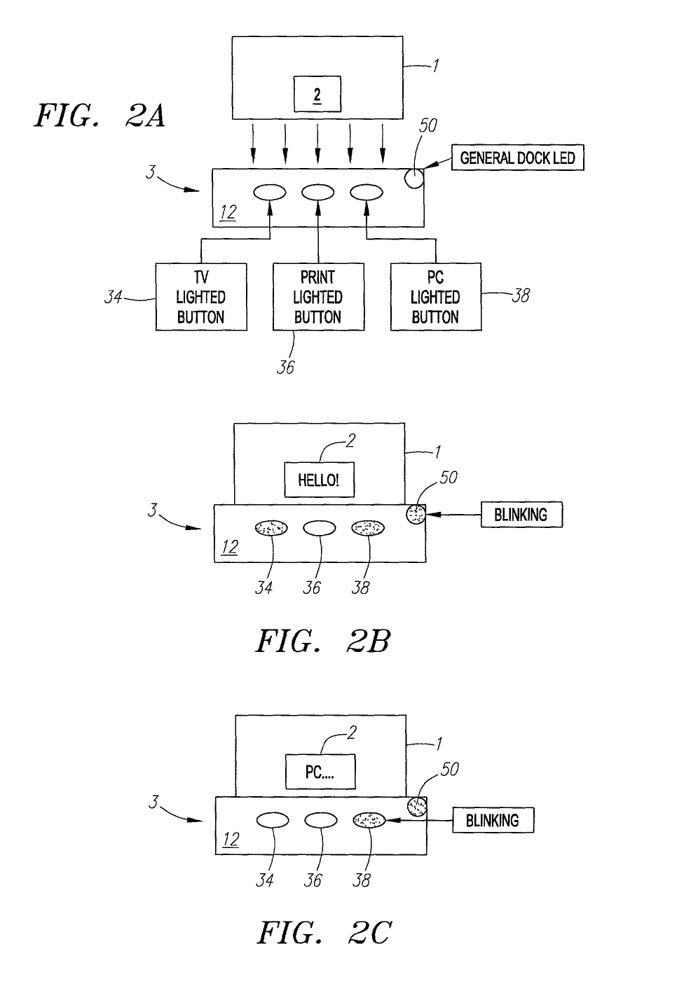

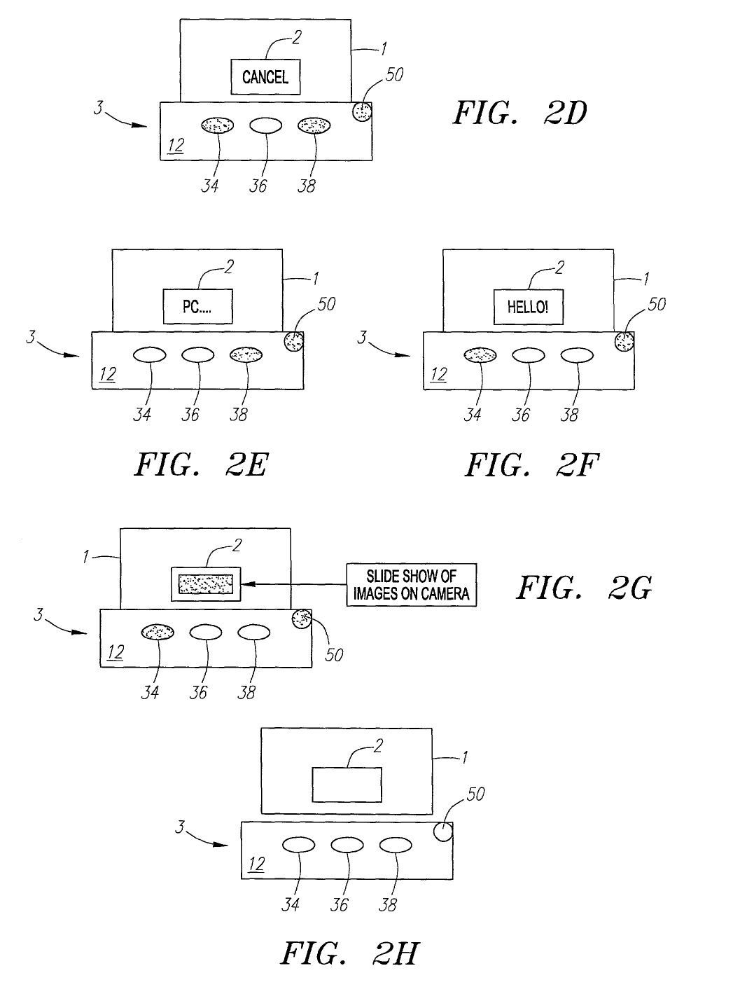

In accordance with an embodiment of the invention, FIG. 2A illustrates a digital camera 1 with rechargeable batteries being lowered to dock 3. Dock 3 may be used as a USB hub (i.e., camera 1 may be connected via dock 3 to several devices including without limitation, a television, a printer, a PC, a personal digital assistant (PDA), a cellular telephone, and a device capable of providing wireless communication). Dock 3 has power and is electrically connected to a television (TV) (not shown) and a PC (not shown). Camera mount 12 includes several illuminatable buttons and a light-emitting diode 50. The illuminatable buttons indicate connections between dock 3 and various devices. For example, mount 12 includes illuminatable TV button 34, illuminatable Print button 36, and illuminatable PC button 38 (FIGS. 1A & 2A-H). Buttons 34, 36, 38 may use any known light source including without limitation, LEDs and incandescent bulbs. FIG. 2B illustrates a digital camera 10 mated to dock 3. When docked, TV button 34 and PC button 38 light up (FIG. 2B). LED 50 blinks to indicate that camera 1 is mated to dock 3 (FIG. 2B) and recharging. LCD 2 displays a greeting (e.g., “Hello!”) indicating that the processor of camera 1 is now in docked mode, as described above and below.

TV button 34 indicates a connection between the TV and the docked camera. When button 34 is pressed to start TV activity, the image LCD turns off and a signal is sent to the TV. A continuously running slide show is displayed with each image being displayed for 10 seconds. Using the arrow keys on a remote control, the user can interrupt the automatic slide show and manually advance or reverse the slide show. No other camera controls are available while the camera is docked. When the TV button on the dock is pressed again, display returns to the camera. 1. TV connect button 34 displays status in the following ways: (1) light from button 34 remains solidly illuminated when the TV is available for the mated camera to connect to; (2) light from button 34 is blinking when the mated camera is operationally connected to the TV; and (3) the light from button 34 is off when dock 3 can not connect to the TV. If there is no TV connection, there may still be camera activity with the PC or printer.

Print button 36 indicates a connection between the printer and the docked camera. When button 36 is pressed to start print activity, print selections in the Share menu of the UI are printed and their print status is displayed on image LCD 2. The share menu of the UI allows a user to mark a digital photo such that the photo will be automatically be emailed, printed, or sent to a webpage for posting when the camera is docked. A message explaining this action would be shown on image LCD 2. For some printers (not shown), prior to printing, the processor of camera 1 will need to communicate with the printer's processor regarding paper sizes and paper types applicable to that particular printer. Any printer problems, such as “out of paper” would be reported on image LCD 2. If a PC were connected and turned on, the steps outlined above would be the same, but more information would be available on the PC. When the TV button on the dock is pressed again, display returns to the camera. 1. Print connect button 36 displays status in the following ways: (1) light from button 36 remains solidly illuminated when the printer is available for the mated camera to connect to; (2) light from button 36 blinks when the printer is printing; and (3) the light from button 36 is off when the printer can not print (e.g., no printer is connected, all printing is done, there is camera activity with the TV or the PC).

PC button 38 indicates a connection between the PC and the docked camera. When button 38 is pressed to start PC activity, all email and web selections in the Share menu are executed and all images are downloaded. Feedback is given on camera 1 and on the PC. PC connect button 38 displays status in the following ways: (1) light from button 38 remains solidly illuminated when the PC is available for the mated camera to connect to; (2) light from button 38 blinks when the memory of camera 1 is downloading images to the PC and sharing information with the PC; and (3) the light from button 38 is off when the docked camera can not connect to the PC (e.g., the PC is off or not connected, all PC connection is done, there is camera activity with the TV or printer).

LED 50 indicates the general status of dock 3. Light from LED 50 remains solidly illuminated when the camera is in dock, the dock is activated, and the batteries are filly charged or disposable. Light from LED 50 blinks when the camera is in dock and the batteries are charging. Light from LED 50 is off when no camera is mated to dock 3 and/or there is no power to dock 3.

A remote control (not shown) has two buttons: (1) a left arrow button; and (2) a right arrow button. When there is no camera in dock 3 or dock 3 has no power, all LEDs and illuminated buttons 34, 36, 38 are off. When camera 1 is docked, buttons 34, 36, 38 light up indicating which functions are available. For example, if a printer is connected, print button 36 lights up. A welcome screen is also displayed. If a user presses a button that is not lit, nothing happens. If a user presses a button that is lit, the camera begins the associated activity. In the case of printing and downloading, feedback of the activity status is given on image LCD 2. During that activity, the appropriate button is blinking and the other buttons are off and inactive. In the case of the printing and PC connect functions, when the activity is complete, the light within the associated button turns off. If a user presses a blinking button, the activity is halted. An interrupt message is displayed on image LCD 2 and then all appropriate buttons are illuminated again.

When the camera has been idle in dock 3 for two minutes, camera 1 goes into an electronic picture frame (EPF) mode and displays a continuous slide show on image LCD 2 of the images stored in the memory of camera 1. Camera 1 can be enabled as an addressable receive device such that camera 1 may receive images sent using various means including, without limitation, internet, modem (wireless or otherwise), LAN, local wireless or wireless internet. Buttons 34, 36, 38 remain illuminated to show available connection options.

For example, if a user presses PC button 38, button 38 begins blinking (FIG. 2C). The other buttons 34, 36 are not illuminated while the camera/dock is in PC mode. LED 50 continues to blink and will continue to do so as long as camera 1 is mated to dock 3. LCD 2 displays an acknowledgement that the PC button has been pressed (e.g., “PC . . . ”) indicating that the camera processor is in communication with the CPU of the PC. During this time, the camera processor downloads images from the camera memory to the PC. If a user presses PC button 38 once more, the PC connect is interrupted and LCD 2 displays an acknowledgement of this (e.g., “Cancel”) indicating that the camera processor is no longer in communication with the CPU of the PC. TV button 34 and PC button 38 are again illuminated (FIG. 2D). If a user presses PC button 38 once more, the PC connect is resumed and LCD 2 displays an acknowledgement of this (e.g., “PC . . . ”) indicating that the camera processor is once again in communication with the CPU of the PC. TV button 34 and PC button 38 are again illuminated (FIG. 2D). Again, PC button 38 begins blinking. However, at this point, LED 50 may stop blinking and maintain steady illumination if the batteries are filly recharged (FIG. 2E).

When the download of images from the memory of camera 1 is complete, LCD 2 displays a greeting (e.g., “Hello!”) indicating that the processor of camera 1 is now in docked mode and ready for a new command. TV button 34 is illuminated but PC button 38 is no longer illuminated (indicating that images from camera 1 have been downloaded) (FIG. 2F).

After a period of time (e.g., two minutes), if no input is received from a user, camera 1 is programmed to revert to a default mode and present a slide-show of images stored in the memory of camera 1 on LCD 2 (FIG. 2G). When camera 1 is undocked from dock 3, the processor of camera 1 reverts to normal camera mode and conventional functionality. LED 50 and buttons 34, 36, 38 are no longer illuminated (FIG. 2H).

In accordance with an embodiment of the invention, FIG. 3A illustrates a digital camera 10 being lowered to an alternative mating surface 14 of camera mount 12. Digital camera 10 includes a power supply 16 for powering camera 10, a memory 18 for storing digital images, and a threaded mounting hole 13. Mounting hole 13 is threaded to allow camera 10 to be able to be mounted to a mounting screw of a conventional camera tripod or other similar mounting surface. A female jack 15 is located on the top surface of hole 13. Jack 15 includes a number of pin contacts 17, in one example four. At least two pin contacts 17 are electrically connected to memory 18 (i.e., the processor of camera 10) via a cable or wire 5. At least two additional pin contacts 17 are electrically connected to power supply 16 via a cable or wire 8. Camera 10 may be powered by a battery source, coupled to an AC source or coupled to the power source of another device.

Camera mount 12 includes a trigger 11 and a post 9. As seen in FIG. 3B, post 9 further includes male jack 19. Jack 19 includes a number of pins 7, in one example four. Electrical connections (not shown), including but not limited to wires or USB cable, are routed through the center of post 9 between the pins 7 and a USB connector (not shown) located on mount 12. The USB connector may be connected by USB cable to a PC, notebook computer, CD-Writer, photoprinter or other device. Post 9 press-fits snugly into hole 13. Post 9 need not be threaded. Post 9 made be made of hard rubber or rubber-coated metal (including but not limited to rubber-coated steel). At least two pin contacts 17 are electrically connected to a cable 22 which is electrically connected to a camera memory 18 and at least two additional pins 7 are electrically connected to a camera power source 16. Camera mount 12 may be powered by a battery source, connected to an AC source or connected to the power source of another device.

FIG. 3B illustrates camera 10 mated to surface 14 of camera mount 12. As camera 10 contacts and presses down on trigger 11 (as camera 10 is mated to mount 12), pins 7 extend from post 9 and mate with pin contacts 17. As seen in FIG. 3A, pins 7 are not extended prior to trigger 11 being depressed. Trigger 11 is connected to a mechanical linkage 30 that is connected to jack 19. Depressing trigger 11 exerts force on linkage 30 which is coupled to jack 19 which causes jack 19 to raise within post 9, exposing pins 7 which engage contacts 17. The mating pins 7 and contacts 17 for data are connected to memory 18 through an I/O channel. The mating pins 7 and contacts 17 for power are connected directly to power supply 16.

In an alternative embodiment, a trigger can be implemented in which the camera is guided into alignment with a door located on the flat surface of the camera mount under the camera mounting hole. When the camera is lowered to the surface of the camera mount, the bottom of the camera depresses the trigger. The trigger is connected by a mechanical linkage, similar to the one outlined above, to the door. The door slides open, allowing a combined data/power connector to rise from within the body of the camera mount and protrude from the surface of the camera mount to be inserted into the mounting hole of the camera. The sides of the data/power connector are designed to snap-on the threads inside the camera mounting hole instead of screw-on grip.

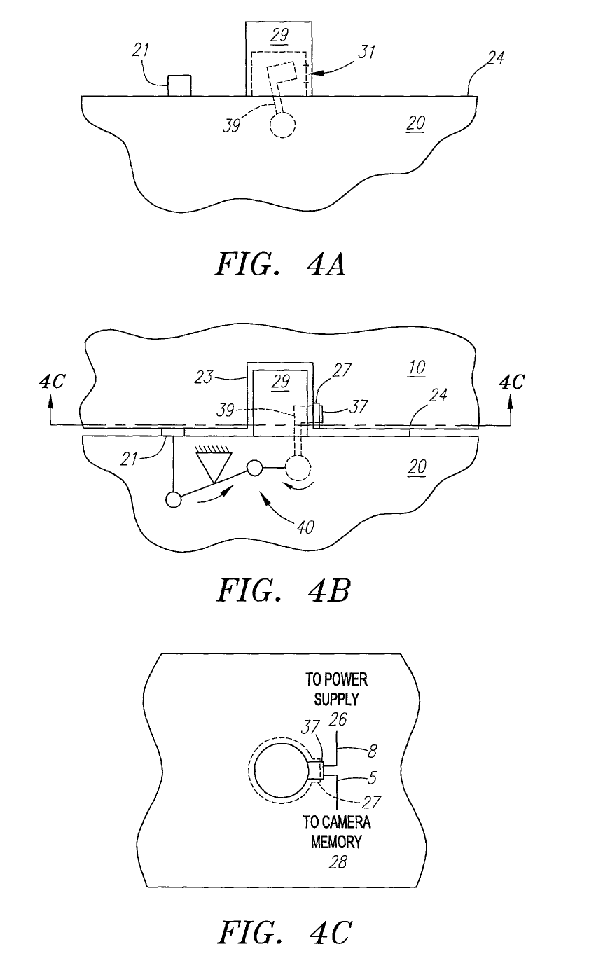

In accordance with an embodiment of the invention, a camera dock includes a camera mount 20. FIG. 4A illustrates a side cross-sectional view of another alternative mating surface 24 of camera mount 20 which includes a trigger 21 and a post 29. As seen in FIG. 4A, post 29 is hollow and includes a flag-like electrical contact 39. Electrical contact 39 includes four connections or pins (not shown). Preferably, two pins dedicated to power are electrically connected to a cable or wire 8 connected to a power supply 26 (not shown) and two pins dedicated to data are electrically connected to a cable or wire 2 connected to a memory 28 (i.e., the processor of camera 10) (not shown). The power and data pins are separated by an insulator. Electrical contact 39 functions as a USB connection. Electrical connections, including but not limited to wires or USB cable, are routed through post 29 between the pins of electrical contact 39 and a USB connector (not shown) located on mount 12. Post 29 press-fits snugly into hole 13. Trigger 21 is connected to a mechanical linkage 40 that is connected to flag-like contact 39. Depressing trigger 21 causes contact 39 to pivot into position, allowing the front edge of the flag-portion to protrude through a slit 31 in the side of post 29 and engage contact pad 37 in camera 10.

FIG. 4B illustrates a side view of camera 10 mounted to surface 24 of mount 20. Camera 10 includes a power supply 26 for powering camera 10, a memory 28 for storing digital images, and a threaded mounting hole 23 (threads not shown for clarity). Mounting hole 23 is threaded so as to allow camera 10 to be able to be mounted to the mounting screw of a conventional camera tripod or other similar mounting surface. Camera contact pad 37, located along a slit in the side of hole 23, includes pins 17 that mate to the pins 7 located on electrical contact 39. If the pins 7 on electrical contact 39 are male, the pins 17 located on camera contact pad 37 are female. Contact pad 37 is electrically connected to memory 28 and/or power supply 26. The pins 7, 17 for data are connected to memory 28 through an I/O channel. The pins 7, 17 for power on contact pad 25 are connected directly to power supply 26.

FIG. 4C illustrates a bottom view of digital camera mounting hole 23. However, instead of hole 23 being formed with perfect threads, a cut is made in the side of hole 23 to form slot 27. The cut may be square, triangular, rectangular, or semicircular. FIG. 4C illustrates a rectangular cut, giving hole 23 the shape of a keyhole. Although the present embodiment illustrates a pivoting flag-like contact, a contact may slide up slot 27 until the contact electrically connects with pad 37. The data connections are electrically connected to memory 28 (i.e., the processor of camera 10) via a cable or wire 5. The power connections are electrically connected to power supply 26 via a cable or wire 8.

The above-described embodiments of the present invention are illustrative only and not limiting. It will thus be obvious to those skilled in the art that various changes and modifications may be made without departing from this invention in its broader aspects. Therefore, the appended claims encompass all such changes and modifications as falling within the true spirit and scope of this invention.

We claim:

1. An camera dock comprising:
a mounting portion for receiving a digital camera comprising an LCD for viewing images;
a support portion pivotally coupled to said docking portion wherein said support portion is in contact with a surface;
wherein said mounting portion further comprises a port for receiving a cable for power and data connections wherein said cable is connected to a processor of another device.

2. The camera dock of claim 1, where said cable is a USB cable.

3. The camera dock of claim 1, wherein said mounting portion further comprises at least one function button for activating/deactivating a first function.

4. The camera dock of claim 1, wherein said support portion further comprises an indent on a bottom portion of the support portion so as to allow said cable to pass under the support portion with sufficient room so as to not lift the support portion off of the surface.

5. The camera dock of claim 1, wherein said support portion further comprises an infra-red sensor for remote operation of said dock.

6. The camera dock of claim 1, wherein said mounting portion further comprises at least one illuminated button for activating/deactivating a first function.

7. The camera dock of claim 6, wherein said first function is selected from the group consisting of: television, printer and PC.

8. The camera dock of claim 1, wherein said mounting portion further comprises a first illuminated button, a second illuminated button and a third illuminated button wherein each button activates/deactivates a particular function.

9. The camera dock of claim 8, wherein said first illuminated button activates/deactivates a television function.

10. The camera dock of claim 8, wherein said second button activates/deactivates a printer function.

11. The camera dock of claim 8, wherein said third button activates/deactivates a PC function.

12. The camera dock of claim 1, wherein said mounting portion further comprises a light-emitting diode indicating a status of the camera dock.

13. The camera dock of claim 1, wherein said camera is mounted to said dock such that said LCD faces a user.

14. A camera mount comprising:
a hosting device including a flat surface for mounting a camera including a user interface;
a hollow post on said flat surface wherein said post is sized to fit within a mounting hole of the camera;
a trigger device for raising and lowering a first connector located within the hollow post wherein said first connector mates with a complementary connector located within the mounting hole of the camera; and
wherein the user interface of the camera also functions as the user interface of the hosting device.

15. The camera mount of claim 14, wherein the first connector is coupled to a power source.

16. The camera mount of claim 14, wherein the first connector is coupled to a memory device.

17. The camera mount of claim 14, wherein the first connector includes pins for data connections to a memory of the camera.

18. The camera mount of claim 14, wherein the first connector includes pins for power connections to a power supply of the camera.

19. The camera mount of claim 14, wherein the first connector is located within said hollow post.

20. The camera mount of claim 14, wherein the trigger device is coupled to a mechanical linkage for raising and lowering the first connector.

21. The camera mount of claim 14, wherein the post press-fits snugly into the mounting hole of the camera.

22. The camera mount of claim 14, wherein the post is threaded.

23. The camera mount of claim 14, wherein the post is made of rubber.

24. The camera mount of claim 14, wherein the first connector includes a flag-shaped contact for connecting to a memory of the camera.

25. The camera mount of claim 14, wherein the first connector includes a flag-shaped contact for connecting to a power supply of the camera.

26. A method of displaying digital images comprising:
coupling a digital camera to a camera mount wherein the camera mount is electrically connected to said digital camera; and
displaying digital images on an LCD of said digital camera.
